(19) United States
(12) Patent Application Publication
(10) Pub. No.: US 2008/0149240 A1
(43) Pub. Date: Jun. 26, 2008

(54) Method for curing non-uniform, rubber articles such as tires

(76) Inventors: Michael J. Luneau, Simpsonville, SC (US); Christopher S. Madden, Simpsonville, SC (US)

Correspondence Address: MICHELIN NORTH AMERICA, INC.;INTELLECTUAL PROPERTY DEPARTMENT, MARC BLDG 31-2, 515 MICHELIN ROAD, GREENVILLE, SC, 29605, US

(21) Appl. No.: 11/642,434

(22) Filed: Dec. 20, 2006

(51) Int. Cl. B29C 35/02; B60C 11/03

(52) U.S. Cl. 152/209.15; 264/347; 425/383

(57) ABSTRACT

A method to cure non-uniform rubber articles uses independently heatable, pin heat transfer elements to provide an efficient and practical means of reducing the total cure time of the article in the mold and optimizing the cure state of the article without substantially changing the function or degrading the performance of the article. Reductions in cure time of 10% or more can be achieved. The method is particularly useful for curing tires and tire treads. Finite element analysis or thermocouple probes can used to determine the state of cure for each part of a tire or a tread for a tire. From this knowledge of the cure-limiting parts, one or more independently heated, pin heat transfer elements are added to the interior surface of a tire or tread mold to transfer heat into the cure-limiting parts and to provide a more uniform state of cure.

### BACKGROUND OF THE INVENTION

1. Field of the Invention

The present invention is in the field of curing non-uniform rubber articles, and more particularly in the field of curing tires such as truck tires.

2. Description of the Related Art

Rubber articles, such as tires, for years have been vulcanized or cured in a press wherein heat is applied externally through the tire mold and internally by a curing bladder or other apparatus for a certain length of time to effect vulcanization of the article. Presses for tires are well known in the art, and generally employ separable mold halves or parts (including segmented mold parts) with shaping and curing mechanisms, and utilize bladders into which shaping, heating and cooling fluids or media are introduced for curing the tires. The aforesaid curing presses typically are controlled by a mechanical timer or a programmable logic controller (PLC) which cycles the presses through various steps during which the tire is shaped, heated and in some processes cooled prior to unloading from the press. During the curing process the tire is subjected to high pressure and high temperature for a preset period of time which is set to provide sufficient cure of the most non-uniform part(s) of the tire. The cure process usually continues to completion outside the press.

Rubber chemists are faced with the problem of predicting the time period within which each part of the rubber article will be satisfactorily cured and, once such a time period is established, the article is heated for that period. This is a relatively straight-forward analysis for curing a rubber article that is relatively thin and has uniform geometry and/or similar composition throughout. It is a much more difficult analysis when this is not the situation such as curing a complex article like a tire. This is particularly true when curing large tires such as truck tires, off-the-road tires, farm tires, aircraft tires and earthmover tires. The state and extent of cure in these types of tires is affected not only by the variance in geometry from part to part in the tire but also by composition changes and laminate structure as well. While the time control method has been used to cure millions of tires, because of the varying composition and geometry in the tire, some parts of the tire tend to be more cured than other parts. By setting the time period to cure the most difficult part(s) to cure, over-cure of some part(s) can occur; and production time on the vulcanizing machinery is wasted and production efficiency is reduced.

### SUMMARY OF THE INVENTION

A particular embodiment of the present invention is an improved method of curing tires, treads for tires and other non-uniform articles using conventional curing molds and presses, by making or adapting a mold by adding at least one pin heat transfer element located in at least one position in the mold, which pin heat transfer element can be independently heated. More particularly, the pin heat transfer element is located at a position where heat is directed into cure-limiting parts of the rubber article. The method not only results in a shorter cure time for the article but also results in a more uniform cure state of the rubber article. The selection, positioning and use of the pins do not significantly change the function or significantly degrade the performance of the rubber article. The pins leave a small aperture(s) on the surface area of the part acted upon, such as a tread block. (See FIG. 3, showing a block 20 with apertures 50). The reduction in the surface area of the part caused by the use of one or more of the pins ranges from about 0.1% to about 1.0% of the surface area of the part acted upon. Of particular note, the mold and the curing apparatus as a whole are only slightly altered, and the compositions of the rubber article do not have to be changed or adjusted. An improvement in the state of cure is achieved with a reduction in total cure time in the mold which, thereby, increases productivity.

A further embodiment of the invention is a method of making or adapting a mold for curing tires, treads or other non-uniform articles comprising the step of affixing at least one independently heatable, pin heat transfer element onto the interior surface of a mold so as to intrude into at least one portion of the article during cure. A particular embodiment involves placing one or more pin heat transfer elements in locations on the surface of a mold so that, when a rubber article is placed in the mold, the pin heat transfer elements protrude into those parts of the article that require additional heat during the curing of said article. This is particularly useful for tire molds. When a tire is placed in a mold which has one or more independently heatable pin heat transfer elements located at cure-limiting parts of the tire, a shorter cure time and a more even curing of all portions of the tire is achieved.

### BRIEF DESCRIPTION OF THE DRAWINGS

FIG. 1 shows a top section of a conventional flat tread mold for manufacturing a cured tread for recapping a tire. The top part produces the sculpture to the tread. No. (10) refers to the mold section which imparts the large “full depth” grooves to the tread pattern, which grooves form the tread blocks (20).

FIG. 2 shows a cured tread pattern for a tread for recapping a tire which is cured in a conventional manner. The large longitudinal grooves (10) and the tread blocks (20) are shown. The tread has a thickness of about 25 mm (30) from its bottom surface to the top surface of the tread blocks. The depth of the lateral grooves is about 22 mm (40).

FIG. 3 shows a cured tread pattern for a tread for recapping a tire which is cured using pin heat transfer elements. The only difference between the cured tread pattern in FIG. 2 and that shown in FIG. 3 is the presence of the “pin holes” (50). The pin holes in the figure have a depth from the top surface of the tread block of about 14 mm.

FIG. 4 shows the rate of cure as a function of time for various positions of thermocouple probes in the tread, for the cured treads shown in FIGS. 2 and 3. The first probe is set at a depth of 1 mm from the top surface of a tread block; the second probe is set at a depth of 8 mm from the top surface of the same tread block; and the third probe is set at a depth of 14 mm from the top surface of the same tread block. The cure rates are shown at the 1 mm depth, the 8 mm depth and the 14 mm depth for both the tread cured using the conventional cure method without the pins, as indicated at the locations 100, 110 and 120 in FIG. 4; and the tread cured using the pins, as indicated at the locations 200, 210 and 220 in FIG. 4.

FIG. 5 shows the cure state (alpha) after a fixed press cure time of 26 minutes at thermocouple probe depths of 1 mm, 6 mm, 10 mm, 14 mm, 18 mm and 22 mm from the top surface of a tread block, for the cured treads shown in FIGS. 2 and 3. The cure states are shown at the above depths for both the tread cured using the conventional cure method without the pins, as indicated at locations 300, 310, 320, 330, 340 and 350 in FIG. 4; and the tread cured using the pins, as indicated at locations 400, 410, 420, 430, 440 and 450 in FIG. 5.

FIG. 6 shows the cure time in seconds needed in the press to reach a cure state of alpha=0.9 at the same thermocouple tread depths given in FIG. 5 above, for the cured treads shown in FIGS. 2 and 3. The time to reach alpha=0.9 at each depth for the tread cured using the conventional cure method is shown as line no. (500), and the time to reach alpha=0.9 at each depth for the tread cured using the pins is shown as line no. (510).

FIG. 7 is a partial profile of a typical truck tire shoulder area showing the complexity and non-uniformity of the tire.

FIG. 8 shows the thermal profile in the shoulder of the truck tire profile of FIG. 7 when the tire is removed from the press and is cured using conventional time control methods.

FIG. 9(a) shows a mold section for a truck tire that has been adapted to include multiple pin heat transfer elements (1000) which have a height of about 22 mm. The mold section which produces the lateral groove at the shoulder has a height of about 24 mm (610). FIG. 9(b) shows a cross-section view of an independently heatable pin heat transfer element and shows electrical resistance as the heating source.

FIG. 10(a) shows the location of multiple pin holes (50) in the tread blocks (20) of a cured truck tire. FIG. 10(b) shows the depth of a pin hole (50) in the tread block (20).

### DETAILED DESCRIPTION OF PREFERRED EMBODIMENTS

In the process of curing a tire, a tread for a tire or other non-uniform rubber articles, the challenge for the industry is to provide a curing process that provides a sufficient amount of heat energy to the non-uniform parts of an article to effect substantial cure of said parts without overcuring other parts of the article, and to do so in a productive, time-efficient manner.

In an embodiment of the invention, the method uses one or more independently heatable, pin heat transfer elements which protrude from the surface of a mold and intrude into a rubber article to cause a shorter cure time in the mold.

In a particular embodiment of a method of the invention, one first determines which part(s) of a non-uniform rubber article require additional heat energy to affect an efficient and substantial cure of said parts. This can be done using known techniques such as finite element analysis (FEA) or thermocouple probes to determine the state of cure for each zone of the article. From the knowledge of these zones and the cure rates of the compositions, different parts of the article are identified to receive enhanced heat transfer in order to provide a shorter cure time and a more even cure for the article. The invention uses pins as an efficient and practical means of accomplishing this goal. The use of the method results in a more uniform state of cure for all parts of a non-uniform article such as a tire or tread, resulting in a reduction in cure time in the press. Reductions in cure time in the press of up to 10% or more can be obtained. In addition, the use of this improved curing method does not change the function of the article, and has no substantial negative impact on the performance of the article.

Hence, a particular embodiment of the present invention is a method of curing a non-uniform rubber article comprising the steps of:

placing the article inside a mold;

inserting one or more independently heated pin heat transfer elements into one or more cure-limiting parts of the article at a depth of between about 25% and about 60% of an overall thickness of the article;

applying heat to the mold and the pin heat transfer elements until the article reaches a defined state of cure;

removing the one or more pin heat transfer elements from the article; and removing the article from the mold, wherein the one or more pin heat transfer elements have a total cross-sectional area at the interior surface of the mold of between about 0.1% and about 1.0% of the total surface area of the one or more cure-limiting parts of the article into which the one or more pin heat transfer elements were inserted. This method is particularly applicable as a method of curing a tread for a tire.

Another embodiment of the present invention is particularly applicable as a method of curing a tire comprising the steps of:

placing a tire inside the mold;

inserting one or more independently heated, pin heat transfer elements into one or more cure-limiting tread blocks or ribs of the tire at a depth of between about 50% and about 110% of a tread depth of the block or rib;

applying heat to the mold and the pin heat transfer elements until the tire reaches a defined state of cure;

removing the one or more pin heat transfer elements from the tire; and

removing the tire from the mold, wherein the one or more pin heat transfer elements have a total cross-sectional area at the interior surface of the mold of between about 0.1% and about 1.0% of the total surface area of the one or more cure-limiting tread blocks or ribs of the tire into which the one or more pin heat transfer elements were inserted.

Further embodiments of the invention include molds for curing tires, treads for tires and other non-uniform rubber articles, wherein the pin heat transfer elements of the mold are independently heatable, i.e., can be heated by a source other than by conduction of heat via the mold. Hence, the mold has at least one interior face which contacts an article, which interior face has at least one pin heat element protruding outward from the interior face of the mold, whereby heat is transferred by and through the pin to the article during cure.

Another particular embodiment of the invention is a tire or a tread for a tire which is made by the method of the invention.

### Finite Element Analysis

According to a particular embodiment of the invention, an evaluation is made of the heat transfer which occurs during cure to parts of an article such as a tire or tread using conventional methods. One known method of determining heat transfer is to build a tire, place thermocouples within the tire or tread and record the thermal profiles during the curing process. Knowing the thermal profile, one can use reaction kinetics to determine the state of cure throughout the tire.

Another known method is to use Finite Element Analysis (FEA) which consists of a computer model of an article that is subjected to external loads (i.e., thermal) and analyzed for results. Heat transfer analysis models the conductivity or thermal dynamics of the articles. See, e.g., Jain Tong et al, “Finite Element Analysis of Tire Curing Process”, Journal of Reinforced Plastics and Composites, Vol. 22, No. 11/2003, pages 983-1002.

### State of Cure and Alpha

Alpha is a measure of the state of cure for a rubber composition, and is given by the following equation:

alpha=(time of curing)/t99

where t99 is the time for completion of 99% of the cure as measured by torque as shown by a rheometer curve. ASTM D2084 and ISO 3417 describe how to measure cure times (time t0 for the onset of cure, and time t99 for 99% completion of cure) for rubber compounds using an oscillating rheometer. These standards are incorporated by reference.

The method of the invention will now be described to show how it differs from conventional cure processes and molds. The method of the invention is directed to curing non-uniform rubber articles such as tires and treads for tires. By “non-uniform” is meant (a) varying geometrical thickness in the article, (b) varying materials composition in the article, (c) presence of laminate structure in the article, and/or (d) all of the above. A typical large tire, such as a truck tire, off-the-road tire, farm tire, airplane tire or an earthmover tire, is a good example of a non-uniform rubber article. However, any non-uniform rubber article, such as hoses, belts, vibration mounts, bumpers, etc., can be efficiently cured using the method of this invention.

In a conventional curing method using a conventional mold, an analysis can also be made of the rate of heating in all parts of the rubber article. However, even knowing this, the result is that the total cure time period to cure the article is dictated by the time it takes to substantially cure the “cure-limiting” part(s) of the rubber article. By “cure-limiting” is meant the part(s) of the article that takes the longest time to cure due to the non-uniformity of the article such as the heat transfer and cure rate characteristics of the composition, and the thickness and/or complexity of the article. Hence, by setting the total cure time period to cure the cure-limiting parts, longer cure times are used which results in, at least, inefficient use of the curing apparatus. The method of the invention achieves (a) a reduction in the total cure time period in the press and (b) a more uniform state of cure, without substantially changing the function or degrading the relative performance of the article.

As in the conventional cure process, the method of the invention can use known FEA analysis, thermocouple analysis or other means to determine the various rates and states of cure in the parts of the tire. In the present method, the lengths, diameters and configurations of pin heat transfer elements are defined which are effective in reducing the total cure time and achieving a more uniform state of cure without substantially changing the function or degrading the relative performance of the article.

The pin heat transfer elements can be made from any thermally conductive material compatible with the mold; and are typically made from steel or aluminum. One or more pins can be added to the mold in known ways such as by welding, by drilling holes through the mold and inserting the pins through the mold so as to protrude outward from the surface of the mold, or the pins can be designed into a new mold. Hence, more curing capacity is achieved with little capital expenditure.

The pin heat transfer elements can have any cross-sectional shape, such as round, square, triangular, hexagonal, octagonal, rectangular or elliptical. The pins can be thought of in terms of their nominal “x-y” geometry (i.e. the shape of the pin in the two dimensional “x and y” planes). If the horizontal “x and y” plane dimensions are substantially symmetrical (i.e. the “x and y” dimensions are approximately equal), the pin is basically round, square, hexagonal, octagonal, etc. If the pin has an asymmetrical shape (i.e. the “x and y” dimensions are substantially different), the pin is basically rectangular, elliptical, etc.

The cross-sectional area of the pin heat transfer element at the interior surface of the mold ranges from about 0.1% to about 1.0% of the surface area of the part acted upon, such as a tire block or rib. Hence, the use of a pin leaves only a small aperture in the surface of the article. If more than one pin heat transfer element is used, the combined cross-sectional area of all of the pins still ranges from about 0.1% to about 1.0% of the total surface area of the part acted upon, such as the tire block or rib.

To exemplify the dimensions of the pin heat transfer element, truck tires having a block type tread pattern have a typical nominal surface area for the tread blocks ranging from about 900 mm² (i.e. about 30 mm by 30 mm) to about 5625 mm² (i.e. 75 mm by 75 mm). In this case, a pin, which has a cross-sectional area of from about 0.1% to about 1.0% of the surface area of the tread block, can have “x and/or y” dimension for the pin ranging from about 1 mm to about 7 mm.

The length of the pin heat transfer element in the vertical “z” dimension (i.e. the direction into the part being acted upon) is such that they extend into the article from about 25% to about 60% of the overall thickness of the article. For tires, the pins have a “z” dimension that extends about 25% to about 110% of the thickness of the tread depth; and, more preferably, from about 50% to about 90% of the tread depth. For example, for a typical truck tire that has a nominal tread depth thickness of about 26 mm, the “z” dimension (length) of the pins ranges from about 5 mm to about 28 mm; and preferably from about 13 mm to about 24 mm.

For treads for tires, which basically have geometric non-uniformity (but can also have compositional non-uniformity), it is efficient to use one or more pins having a “z” dimension so as to protrude into the tread block by about 25% to about 50% of the total thickness of the tread. Hence, for a typical tread cap having a total thickness of 28 mm, the pins would have a “z” dimension (length) of from about 7 mm to about 14 mm.

The “z” dimension of the pin heat transfer element can protrude into the article perpendicular to the “x and y” dimension, or can be inclined. The pins can also be tapered at the top or bottom, or have a shape in the “z” dimension such as to show a “step-down” or a rounded “head” at the bottom like a mushroom shape.

It is sometimes preferable to use multiple pin heat transfer elements having a smaller cross-sectional area at the interior surface of the mold (i.e. each ranging from about 0.1% to about 0.4% of the surface area of the part acted upon) than to use one or more pins having a larger cross-sectional area at the interior surface of the mold (i.e. each ranging from about 0.5% to about 1.0% of the surface area of the part acted upon). This can be the case when there is a concern that a larger pin would leave an aperture on the surface of the block large enough to collect stones and debris, or when a tire has a rib design as opposed to a block design. If more than one pin is used, it is preferable to separate the pins from each other by a distance of about seven times the average dimension of the pin. For a typical truck tire tread block, the distance between pins would be about 10 mm or more. When a very large tire, such as an earthmover tire, is cured, it may be practical to use one or more larger pins.

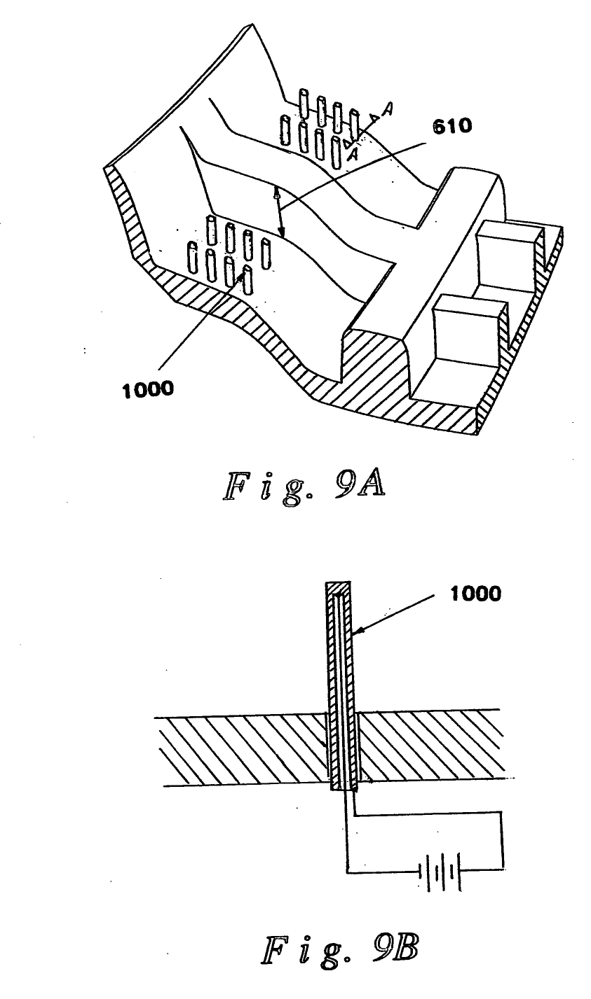

The pin heat transfer elements are independently heatable. This means that the pins can provide their own heat in addition to and independent of the heat transferred to the pins via conduction from the mold. This further reduces the time in the mold to cure the article to the desired state of cure. The heating of the pins can be accomplished in known ways such as using a heater to apply heat convectively to the pins before the article is inserted into the mold. A particular embodiment involves the use of electrical resistance to heat the pins. This can be seen in FIG. 9(b). The heating of the pins can continue during the cure of the article. The pins are heated to a temperature of from about 90% to about 110% of the mold temperature chosen for the cure. For tires and treads, the pins are heated to from about 110 degrees Celsius to about 170 degrees Celsius.

Hence, it is readily apparent that the method of this invention allows the practitioner flexibility in choosing the “x”, “y” and “z” dimensions of the pin heat transfer elements, and in choosing the shape, number and configuration of the pins, in order to obtain the desired cure results.

The method of the invention will be further described with respect to its use in curing tires and treads. However, it is understood that the method can be used with other non-uniform rubber articles.

### Impact of Use of the Pins on the Tire.

As mentioned, the protrusion of the pin heat transfer element into the tire rib or tread block causes an aperture on the surface of the rib or block. To minimize the impact of the use of the pin heat transfer element on the function and performance of the tire, the reduction in the total surface area of the tire rib or tread block on which a pin, or multiple pins, acts ranges from about 0.1% to about 1%, and preferably from about 0.1% to about 0.5%, of the surface area of the tread block or rib acted upon.

Further, in order for the tire to function in its intended manner, the rigidity of the tire tread block or rib should not be substantially degraded by the apertures caused by the pin heat transfer element(s). For tire treads, this means that the tread block should maintain rigidity after the use of the pins similar to that it would have if the pins were not used. The change in rigidity is related to the percent reduction in volume of the part acted upon which is caused by the use of the pin heat transfer element. For this invention, the use of one or more of the pins should cause a total reduction in the calculated rigidity of the tread block of 6% or less, and preferably of 2% or less.

The reduction in rigidity is calculated by the formula “volume of the aperture(s) created by the pin(s)” divided by the “total volume of the part of the article which has been acted upon by the pin(s)”.

When the rigidity calculation is applied to a tire tread block, a multiplier was applied. The multiplier value was “1” for the first increment of 1 to 5 mm of depth; the multiplier was “2” for a second increment of over 5 to 10 mm of depth; the multiplier was “4” for a third increment of over 10 to 15 mm of depth; and the multiplier was “8” for any other increment of over 15 mm of depth or more.

If more than one increment is involved (which is the case for longer pins), the rigidity is calculated for each increment and the values obtained are added to give the total reduction in rigidity. For example, if a cylindrical pin heat transfer element is used which protrudes into a tread block by 14 mm, this leaves a “cylindrical hole” in the block which corresponds to the diameter and length of the pin. So, a rigidity calculation would be made for the volume of the aperture in first five mm increment and the multiplier is “1”. For the second five mm increment, another rigidity calculation is made for the volume of the aperture in the second increment and the multiplier is “2”. For the last four mm increment, another rigidity calculation is made for this increment and the multiplier is “4”. Then, the three calculations are added together to get the total reduction in rigidity caused by the pin. If more than one pin is used, a rigidity calculation is made for each pin. The calculations are then added together to get a combined value for the reduction in rigidity. The same process is used for all the shapes for the pin heat transfer elements.

The following description illustrates the method of the invention.

### Example, Cure of a Tread for Recapping a Tire.

The use of pin heat transfer elements is demonstrated with the cure of a tread for recapping a tire.

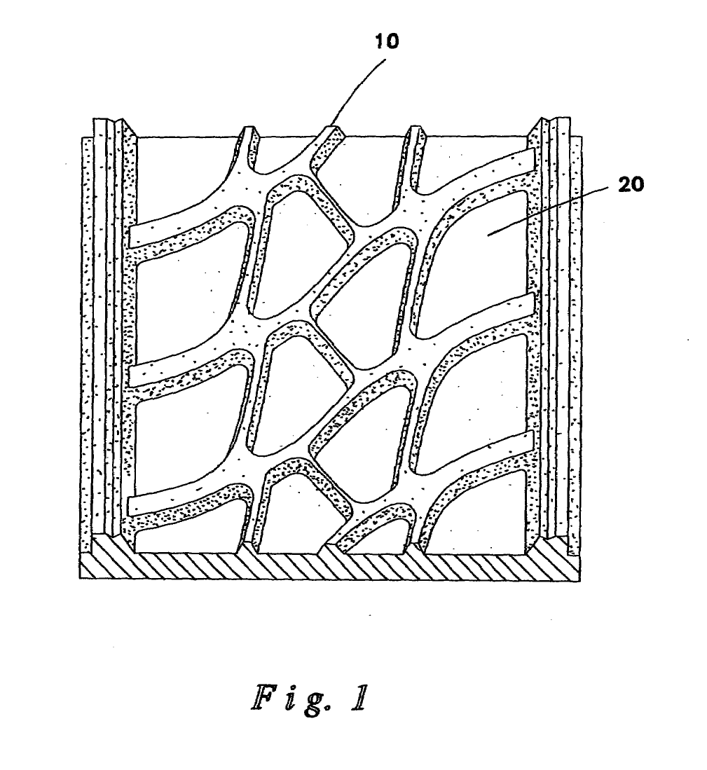

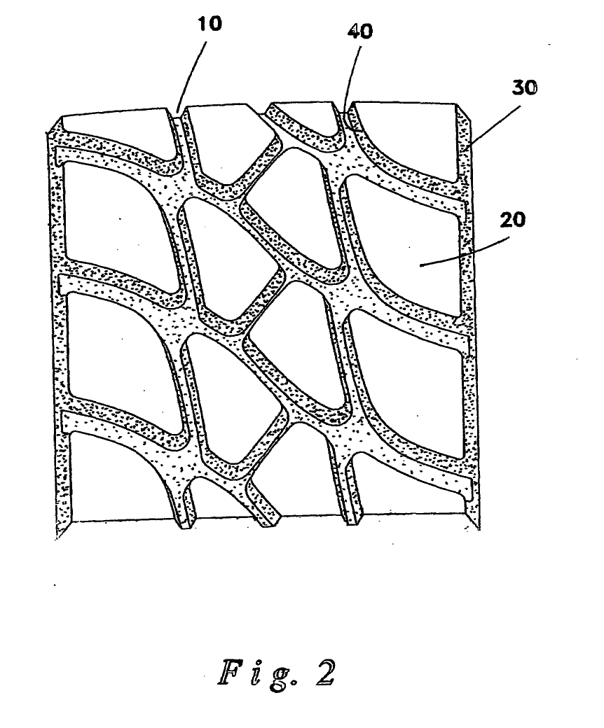

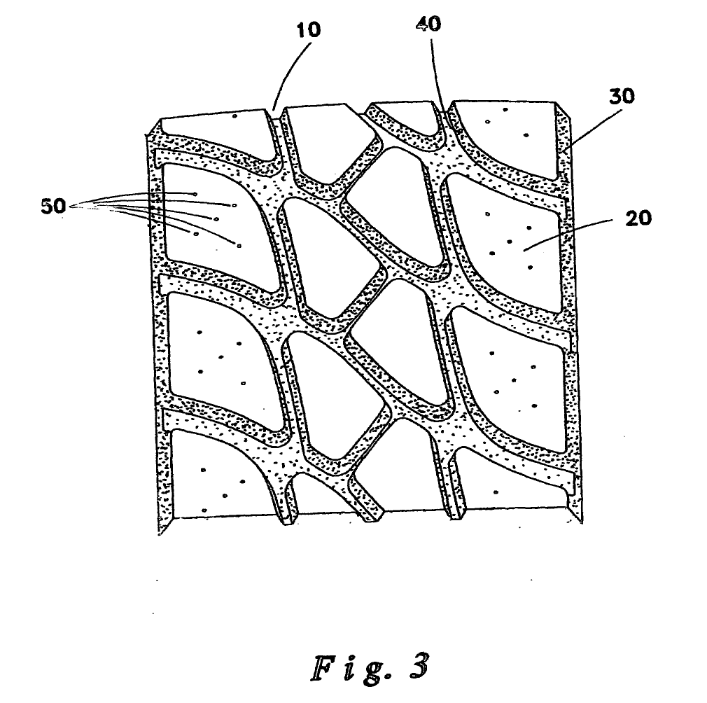

FIG. 1 shows a conventional flat tread sculptured mold segment for a pre-cured tire tread. FIG. 2 shows a sculptured tread pattern for the tread as a result of using the mold of FIG. 1 and using a conventional molding process. FIG. 3 shows the sculptured tread pattern resulting from the addition of pin heat transfer elements to the mold of FIG. 1. In defining the relative locations for the pins, the minimum cure-state location was first identified in the x-y plane of the tread pattern. This position was then used as a basis for comparison of the state of cure in the z-direction (or through the thickness of the tread block). The process of the invention can be used with a uniform composition tread or with a non-uniform tread such as a first tread layer used over a second tread layer.

In a commercial platen precure retread press, the top and bottom platens are heated with a circulating hot oil system. The platens are manufactured with internal oil tubes which are designed to provide an even distribution of energy. With a proper heat exchange system and oil temperature regulation, the platens temperature can be controlled to within a target range of plus or minus 3° Celsius.

The tread pattern used for this example is shown in FIG. 2. Due to the large shoulder blocks, the cure time required in the press was 25 minutes using conventional curing conditions in the platen press.

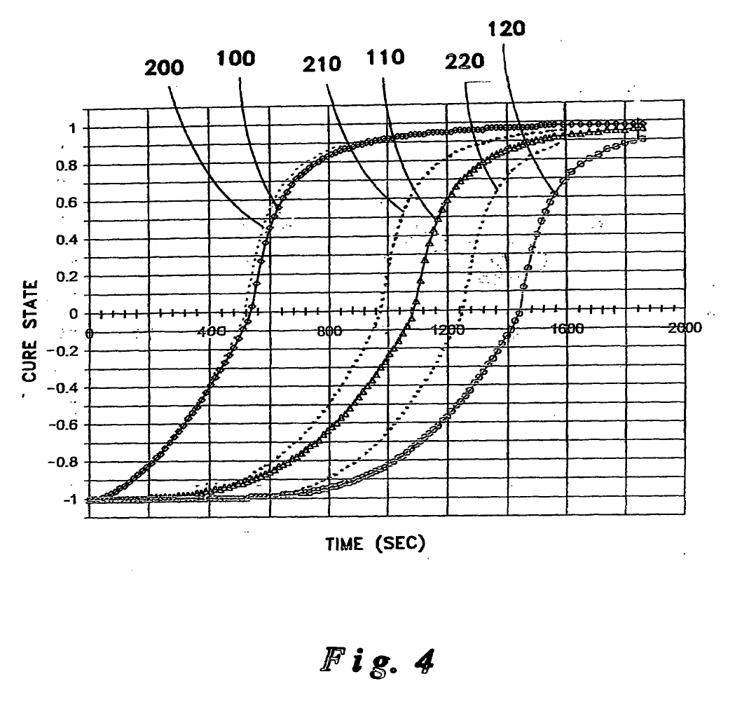

To quantify the state of cure in all sections of the tread, probes were placed in the tread. The first probe was placed about 1 mm below the top surface of the tread. A second probe was placed at about 8 mm below the top surface of the tread; and a third probe was placed at about 14 mm below the top surface, near the center of the tread. The temperature profiles were generated for the three points (see FIG. 4). The state of cure for all sections of the tread after cool down should be alpha>0.9.

Inherent in the curing process is the fact that rubber is a very poor conductor of heat, and often, unavoidably, a non-uniform state of cure is often obtained. For this example, using a conventional cure method, the surface of the tread block at 1 mm achieved a sufficient state of cure at approximately 800 seconds (100), while the center of the block at 14 mm required about 1800 seconds of cure time in the press (120).

The mold was modified by adding a combination of 2 mm diameter steel pin heat transfer elements in selected tread blocks. An advantage of using the steel pins was the ability to modify an existing mold. Because the mold is fabricated from flat aluminum segments, it is easy to locate and drill precision holes from the back of the mold through to the tread molding surface. The pins can then be placed through the holes and fixed in place.

The pin pattern for this tread design is shown in FIG. 3. The pins were positioned in the mold so that they would protrude into the large shoulder blocks in a five pin pattern and perpendicular to the surface of the tread block. The pins protruded into the tread block to a depth of about 14 mm (50% of the overall thickness of the tread).

FIG. 4 shows the cure as a function of time for various positions of the thermocouple probes in the tread. The first probe was set at a depth of about 1 mm from the top surface of a tread block; the second probe was set at a depth of about 8 mm from the top surface of the same tread block; and the third probe was set at a depth of about 14 mm from the top surface of the same tread block. The cure rates are shown in FIG. 4 at the 1 mm depth, the 8 mm depth and the 14 mm depth for both the tread cured using a conventional cure method without the pins (100), (110) and (120); and the tread cured using method of this invention with the pins (200), (210) and (220). Clearly, the tread rubber in the block cures the quickest next to the bottom and top platen, while the rubber near the middle cures the slowest.

In comparing the cure rates at the middle location at 14 mm, (120) and

(220), for the tread cured in the standard mold and for the tread cured in the mold adapted with the pins, it is noted that the addition of the pins reduced the time in the press to cure the tread by approximately three minutes, a 12% reduction in the cure time. When the pin heat transfer elements are independently heated, the time in the mold to cure the tread is further reduced.

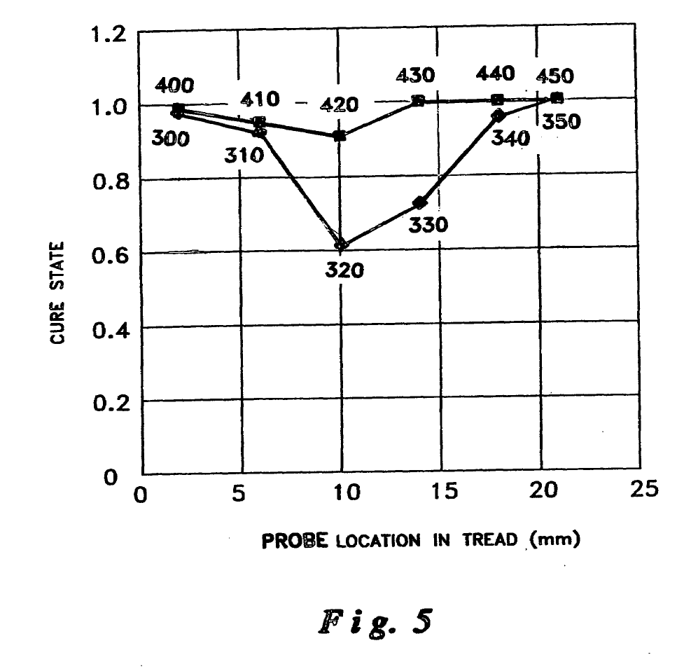

FIG. 5 shows the state of cure through the tread block thickness at the end of the cure. The more flat the curve, the more even the state of cure is through the tread block. The figure demonstrates that the addition of the pin heat transfer elements greatly increased the uniformity of cure through the tread block (compare 400, 410, 420, 430, 440 and 450 with 300, 310, 320, 330, 340 and 350).

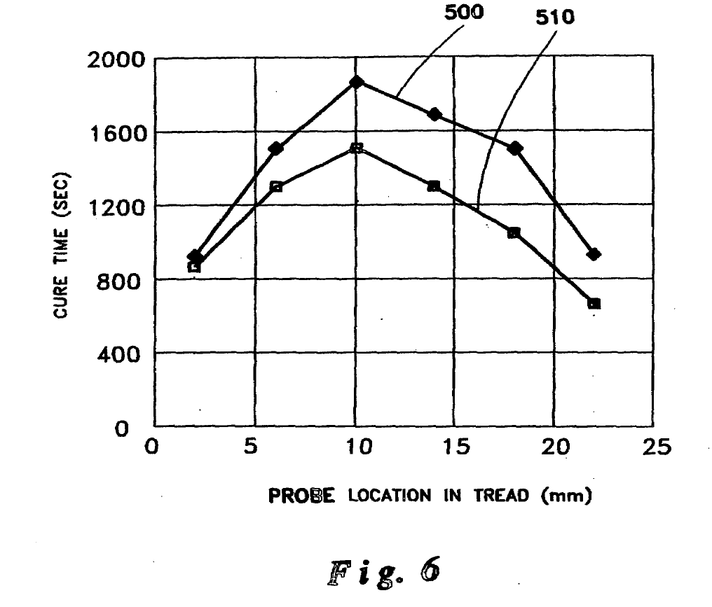

FIG. 6, similarly, shows the time necessary to reach a defined state of cure where alpha=0.90 for different depths in the tread block. It is seen that the addition of the pin heat transfer elements reduced the total time to cure to alpha=0.90 by about 3 minutes (see 510 versus 500 at the 10 mm location). When the pin heat transfer elements are independently heated, the total time to cure the tread to alpha=0.90 is further reduced.

The tread block acted upon has a nominal surface area of about 6075 mm². Hence, the percent reduction in the surface area of the tread block caused by the use of the 2 mm diameter, five pin formation was about 0.2%. The calculated reduction in rigidity of the tread block caused by using the five 14 mm length pins was less than 2%.

### Use of Pins with a Truck Tire.

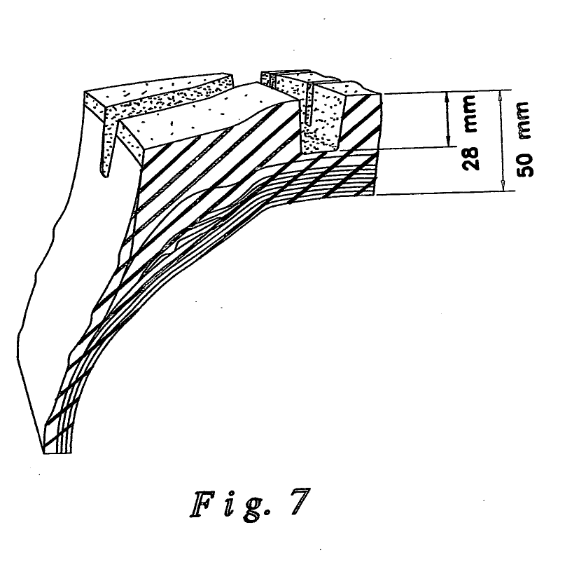

A reduction in mold cure time can be achieved by placing pins into the tread blocks for a typical pneumatic truck tire (FIG. 7 shows the shoulder region of such a tire). The tread block depth is 28 mm and the depth of the lateral grooves is 24 mm. The cure of this tire is limited by the cure of the shoulder area. For example, the cure time for this tire using a conventional method is 56 minutes, while the typical time for the bead to obtain a state of cure of 0.9 is 39 minutes, and for the sidewall, the time is 22 minutes. Hence, the bead part of the tire typically has 17 minutes of additional heating and the sidewall has 34 minutes of additional heating.

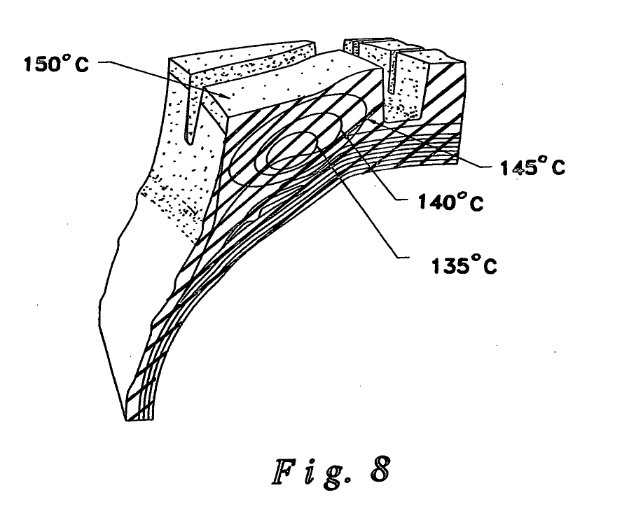

FIG. 8 shows the heat “profile” which is developed in the shoulder region of the tire in FIG. 7 when cured in a conventional manner. It is seen that, at the end of the press cure, the temperature within the center of the tread shoulder block is 15° C. cooler than the temperature at the surface of the tread block.

FIG. 9(a) shows an example of a mold modified with pin heat transfer elements that can be used to introduce heat into the tread blocks of the tire. FIG. 9(b) shows an example of a mold modified with independently heatable pin heat transfer elements.

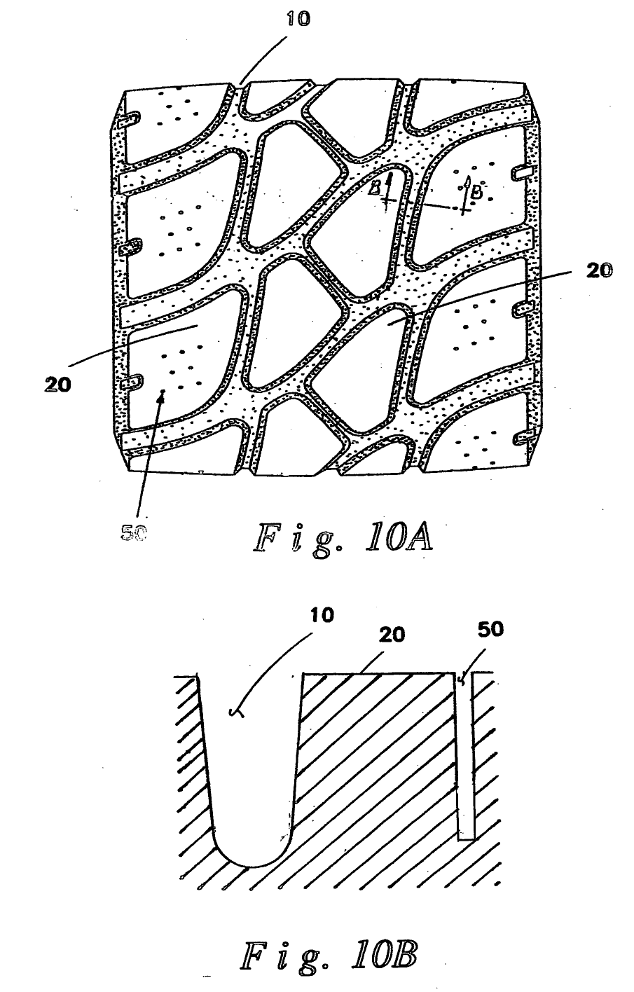

Different shapes, diameters and lengths of pin heat transfer elements, and multiple pins, can be used to transfer heat energy into the cure-limiting zones of the truck tire and reduce the overall cure time, without substantially changing the rigidity of the tread block. The pin heat transfer elements for the truck tire (see FIG. 10) can have having varying lengths of from about 14 mm to about 29 mm (from 50% to about 110% of the tread depth), and varying diameters of from about 2 mm to about 4 mm.

The cure time for the tire can be shortened with the use of independently heatable pin heat transfer elements. The use of longer pins, larger diameter pins and/or the use of multiple pins can also shorten the cure time.

The nominal surface area of the tread block in the tire is about 4200 mm². Hence, the calculated reduction in the surface area of the tread block caused by the pins ranges from about 0.1% to about 0.7%; and the calculated reduction in the rigidity of the tread block caused by the pins ranges from about 0.3% to about 5.5%. The calculations are summarized below.

TABLE 1
Summary of Calculations with Different Pins.

| | | Reduction in |
|---|---|---|
| | Reduction in | Surface Area |
| Case | Rigidity of the Block | Of the Block |
| A) Base case | — | — |
| No Pins | | |
| B) One 2 mm diameter pin | | |
| 1) 14 mm length | 0.3% | 0.1% |
| 2) 18 mm length | 0.8% | 0.1% |
| 3) 22 mm length | 1.0% | 0.1% |
| 4) 26 mm length | 1.2% | 0.1% |
| 5) 29 mm length | 1.2% | 0.1% |
| C) One 4 mm diameter pin | 5.5% | 0.4% |
| 26 mm length | | |
| D) Eight 2 mm diameter | 2.1% | 0.7% |
| pins | | |
| 14 mm length | | |

The objective is to reduce the cure time in the press without significantly degrading the performance or function of the tire. Hence, the pin heat transfer elements are chosen to keep the reduction in the surface area below 1%, and the calculated reduction in rigidity at below 6%.

### Heating the Pin Heat Transfer Element.

The method of a particular embodiment of the invention uses independently heatable pin heat transfer elements which apply additional heat to the article beyond that provided via conduction through the mold.

When a tire is removed from a mold, the heating of the mold is stopped and the mold remains open for a period of time. The mold cools down, and, if there are pin heat transfer elements in the mold, the pins cool down. When another tire is placed in the mold and the mold closed, heating of the mold commences and the pin heat transfer elements are heated via conduction of heat via the mold.

However, to obtain even shorter cure times, the pin heat transfer elements are independently heated using an independent heat source such as electrical resistance. The pins are independently heated to a temperature of from about 90% to about 110% of the mold temperature chosen for the cure of the article. For a tire or tread, this temperature range is from about 110 degrees Celsius to about 170 degrees Celsius.

We claim:

1. A method of curing a tire comprising the steps of:
placing the tire inside a mold; and
inserting one or more independently heated, pin heat transfer elements into the tire.

2. A method of curing a tire comprising the steps of:
placing the tire inside a mold;
inserting one or more independently heated, pin heat transfer elements into the tire at one or more cure-limiting tread blocks or ribs of the tire at a depth of between about 50% and about 110% of the tread depth of the block or rib;
applying heat to the mold and the pin heat transfer elements until the tire reaches a defined state of cure;
removing the one or more pin heat transfer elements from the tire; and
removing the tire from the mold;
wherein the one or more pin heat transfer elements have a total cross-sectional area at the interior surface of the mold of between about 0.1% and about 1.0% of the total surface area of the one or more cure-limiting tread blocks or ribs of the tire into which the one or more pin heat transfer elements were inserted.

3. The method of claim 1, wherein the tire is selected from the group consisting of truck tires, farm tires, off-the-road tires, earthmover tires and airplane tires.

4. The method of claim 1, wherein the tire is a truck tire.

5. The method of claim 2, wherein the calculated percent reduction in rigidity of the tire tread blocks or ribs caused by the one or more pin heat transfer elements is about 6% or less.

6. The method of claim 2, wherein the calculated percent reduction in rigidity of the tread block or rib caused by the one or more pins is 2% or less.

7. The method of claim 2, wherein the percent reduction in surface area of the tread block or rib caused by the one or more pins is 1% or less.

8. The method of claim 2, wherein the percent reduction in surface area of the tread block or rib caused by the one or more pins is 0.5% or less.

9. The method of claim 2, wherein the one or more independently heated, pin heat transfer elements are cylindrical pins which have a diameter of from about 1 millimeter to about 7 millimeters and a length such as to protrude into the cure-limiting parts of the tread blocks or ribs from about 50% to about 90% of the tread depth; and the pin heat transfer elements are independently heated to a temperature from between about 130 degrees Celsius and about 170 degrees Celsius.

10. The method of claim 1, wherein the one or more pins are independently heated to between about 90% and about 110% of the mold temperature.

11. The method of claim 1, wherein the heating of the one or more pins is continued during at least part of the time for the cure of the tire.

12. A method of claim 1, wherein the pin heat transfer element is heated to a temperature from between about 130 degrees Celsius and about 170 degrees Celsius.

13. A method of curing a non-uniform rubber article comprising the steps of:
placing the article inside a mold; and
inserting one or more independently heated, pin heat transfer elements into the article.

14. A method of curing a non-uniform rubber article comprising the steps of:
Placing the article inside a mold;
Inserting one or more independently heated, pin heat transfer elements into the cure-limiting parts of the article at a depth of between about 25% and about 60% of an overall thickness of the article;
applying heat to the mold and the pin heat transfer elements until the article reaches a defined state of cure;
removing the one or more pin heat transfer elements from the article; and
removing the article from the mold;
wherein the one or more pin heat transfer elements have a total cross-sectional area at the interior surface of the mold of between about 0.1% and about 1.0% of the total surface area of the one or more cure-limiting parts of the article into which the one or more pin heat transfer elements were inserted.

15. The method of claim 13, wherein the pin heat transfer element is independently heated to between about 90% and about 110% of the mold temperature chosen for the cure of the article.

16. The method of claim 13, wherein the article is a tread for a tire

17. The method of claim 14, wherein the calculated percent reduction in rigidity of the part of the article acted on by the one or more pins is about 6% or less.

18. The method of claim 14, wherein the calculated percent reduction in rigidity of the part of the article acted on by the one or more pins is 2% or less.

19. The method of claim 14, wherein the percent reduction in surface area of the part of the article acted on by the one or more pins is 1% or less.

20. The method of claim 14, wherein the percent reduction in surface area of the part of the article acted on by the one or more pins is 0.5% or less.

21. The method of claim 14, wherein said one or more pin heat transfer elements are cylindrical pins that have a diameter of from about 1 millimeter to about 7 millimeters and a length such to intrude into the cure-limiting part of the article from about 25% to about 50% of the thickness of said part of the article; and the pin heat transfer elements are heated to a temperature of between about 130 degrees Celsius and about 170 degrees Celsius.

22. A method of claim 13, wherein the one or more pin heat transfer elements are independently heated by a source other than the mold to a temperature between about 130 degrees Celsius and about 170 degrees Celsius.

23. A mold, comprising:
one or more independently heatable, pin heat transfer elements.

24. The mold of claim 21, wherein the mold is for a tire or a tire tread.

25. A tire, comprising:
a tread having tread blocks, tread ribs or combinations thereof, wherein one or more of the tread blocks or ribs have one or more apertures, the one or more apertures having a total cross-sectional area of between about 0.1% and 1.0% of a total surface area of the one or more tread blocks or ribs having apertures; which tire is produced by the method of claim 2.

26. A tread, comprising:
tread blocks, tread ribs or combinations thereof, wherein one or more of the tread blocks or ribs have one or more apertures, the one or more apertures having a total cross-sectional area of between about 0.1% and 1.0% of a total surface area of the one or more tread blocks or ribs having apertures; which tread is produced by the method of claim 14.

27. A tire, comprising a tread of claim 26.
